(19) United States
(12) Patent Application Publication
(10) Pub. No.: US 2025/0181388 A1
(43) Pub. Date: Jun. 5, 2025

(54) INTELLIGENT APPLICATION SCHEDULING

(71) Applicant: INTERNATIONAL BUSINESS MACHINES CORPORATION, Armonk, NY (US)

(72) Inventors: Peng Hui Jiang, Beijing (CN); Jun Su, Beijing (CN); Sheng Yan Sun, Beijing (CN); Guang Han Sui, Beijing (CN)

(21) Appl. No.: 18/527,851

(22) Filed: Dec. 4, 2023

(51) Int. Cl. G06F 9/48; G06F 9/54

(52) U.S. Cl. CPC G06F 9/4881; G06F 9/54

(57) ABSTRACT

Embodiments receive historical application data from at least one historical application, receive incoming application data about at least one incoming application, extract a first set of features from the historical application data and a second set of features from the incoming application data using at least one machine learning model, convert the first set of features to a first set of feature vectors and the second set of features to a second set of feature vectors, perform a vector similarity search by comparing the first set of feature vectors to the second set of feature vectors, determine a matching vector based on the vector similarity search, and schedule execution of the at least one incoming application using a node based on the matching vector.

### BACKGROUND

Aspects of the present invention relate generally to analyzing and scheduling applications in distributed systems.

In a distributed system, there are multiple nodes or servers which are available to run applications. In order to run applications, applications are typically scheduled using heuristics or predefined rules.

### SUMMARY

In a first aspect of the invention, there is a computer-implemented method including: receiving, by a processor set, historical application data about at least one historical application; receiving, by the processor set, incoming application data from at least one incoming application; extracting, by the processor set, a first set of features from the historical application data and a second set of features from the incoming application data using at least one machine learning model; converting, by the processor set, the first set of features to a first set of feature vectors and the second set of features to a second set of feature vectors; performing, by the processor set, a vector similarity search by comparing the first set of feature vectors to the second set of feature vectors; determining, by the processor set, a matching vector based on the vector similarity search; and scheduling, by the processor set, execution of the at least one incoming application using a node based on the matching vector.

In another aspect of the invention, there is a computer program product including one or more computer readable storage media having program instructions collectively stored on the one or more computer readable storage media. The program instructions are executable to: receive historical application data about at least one historical application; receive incoming application data from at least one incoming application; extract a first set of features from the historical application data and a second set of features from the incoming application data using at least one machine learning model; convert the first set of features to a first set of feature vectors and the second set of features to a second set of feature vectors; perform a vector similarity search by comparing the first set of feature vectors to the second set of feature vectors; determine a matching vector based on the vector similarity search; and schedule execution of the at least one incoming application using a node based on the matching vector.

In another aspect of the invention, there is a system including a processor set, one or more computer readable storage media, and program instructions collectively stored on the one or more computer readable storage media. The program instructions are executable to: receive historical application data about at least one historical application; receive incoming application data from at least one incoming application; extract a first set of features from the historical application data and a second set of features from the incoming application data using at least one machine learning model; convert the first set of features to a first set of feature vectors and the second set of features to a second set of feature vectors; perform a vector similarity search by comparing the first set of feature vectors to the second set of feature vectors; determine a matching vector based on the vector similarity search; schedule execution of the at least one incoming application using a node based on the matching vector; and execute the at least one incoming application using the node.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a diagram in accordance with aspects of the present invention.

FIG. 4 shows a flowchart of an exemplary method in accordance with aspects of the present invention.

FIG. 5 shows a diagram in accordance with aspects of the present invention.

FIG. 6 shows a flowchart of another exemplary method in accordance with aspects of the present invention.

FIG. 7 shows a diagram in accordance with aspects of the present invention.

FIG. 8 shows a diagram in accordance with aspects of the present invention.

FIG. 9 shows a diagram in accordance with aspects of the present invention.

FIG. 10 shows a diagram in accordance with aspects of the present invention.

FIG. 11 shows a diagram in accordance with aspects of the present invention.

FIG. 12 shows a flowchart of another exemplary method in accordance with aspects of the present invention.

FIG. 13 shows a flowchart of another exemplary method in accordance with aspects of the present invention.

FIG. 14 shows a flowchart of another exemplary method in accordance with aspects of the present invention.

### DETAILED DESCRIPTION

Aspects of the present invention relate generally to analyzing and scheduling applications in distributed systems and, more particularly, to intelligent application scheduling in distributed systems using a vector database and clustering analysis. Embodiments of the present invention build and use a vector database and clustering analysis for intelligent application scheduling in distributed systems. Embodiments of the present invention analyze historical applications and extract features of the historical applications to build a model by utilizing characteristics and properties of the applications. Embodiments of the present invention generate vector representations (e.g., embeddings) for applications by capturing essential features of each application in a numerical format and ingesting the embeddings into the vector database for efficient querying and retrieval. Embodiments of the present invention employ a clustering-based model to analyze a raw vector database to group application vectors together and create a fine-grained vector database. Embodiments of the present invention analyze characteristics of new applications and extract relevant information of the new applications based on features of the new applications. Embodiments of the present invention perform vector similarity searches using the fine-grained vector database and compare a feature vector of an application to vectors in the fine-grained vector database to identify the closest matches. Embodiments of the present invention utilize a schedule manager to call a vector similarity searcher and find appropriate nodes for scheduling the applications based on matching vectors.

Embodiments of the present invention provide a computer-implemented method, a system, and a computer program product for leveraging historical application data, feature analysis, and vector similarity search to enable intelligent scheduling decisions in a distributed system. Embodiments of the present invention also provide intelligent scheduling to improve resource utilization, reduce execution time, and enhance overall system performance in comparison to conventional systems. In contrast, conventional systems rely on heuristics or predefined rules, which do not adapt well to changing workloads and application characteristics and cause suboptimal task allocation and scheduling decisions. Further, conventional systems may not scale to the complexity and size of distributed systems, which causes performance degradation and difficulties in achieving efficient task allocation. Embodiments of the present invention enable fine-grained application matching based on scheduling requirements by utilizing a combination of vector database and clustering analysis. Embodiments of the present invention identify and match applications with similar characteristics by organizing application vectors into clusters. Embodiments of the present invention enhance a precision of scheduling decisions to ensure that applications are assigned to nodes that meet specific needs by utilizing fine-grained matching.

Embodiments of the present invention include a highly computationally efficient system, method, and computer program product for leveraging vector databases and similarity search techniques to efficiently handle a large number of applications and nodes. Accordingly, implementations of the present invention provide an improvement (i.e., technical solution) to a problem arising in the technical field of scalability and adaptability in distributed systems. In particular, embodiments of the present invention utilize historical data and a machine learning model to adapt to changing workloads and application characteristics to ensure optimal scheduling decisions in dynamic environments. Also, embodiments of the present invention may not be performed in the human mind because aspects of the present invention build and train a historical application model to capture extracted features from historical applications and utilize a clustering algorithm for efficient retrieval and grouping of similar application vectors. Further, these implementations of the present invention refine the historical application and utilize a clustering algorithm based on different applications within a distributed system. In addition, implementations of the present invention provide real-time and dynamic adaptation of changes in scheduling of applications so that the historical application and cluster based models are dynamically updated to adapt to changing workloads and application characteristics.

Implementations of the present invention are necessarily rooted in computer technology. For example, a step of extracting a first set of features from historical application data and a second set of features from incoming application data using at least one machine learning model is computer-based and cannot be performed in the human mind. Extracting features from application data by machine learning is, by definition, performed by a computer and cannot practically be performed in the human mind (or with pen and paper) due to the complexity and massive amounts of calculations involved. For example, extracting the features from application data in embodiments of the present invention may use machine learning to identify and determine relevant characteristics and properties of the applications and organizing application vectors into respective clusters for efficient retrieval and grouping of similar application vectors. In particular, extracting features from application data using machine learning in embodiments of the present invention performs a large amount of processing of current and historical application data and modeling of parameters to extract relevant features of historical application data and incoming application data to generate an output in real time (or near real time). Given the scale and complexity of processing current and historical application data and modeling of parameters, it is simply not possible for the human mind, or for a person using pen and paper, to perform the number of calculations involved in extracting features from application data using machine learning.

Aspects of the present invention include a method, system, and computer program product for performing intelligent application scheduling in distributed systems. For example, a computer-implemented method includes: analyzing historical applications and extract features to build a model by understanding characteristics and properties of the historical applications; generating vector representations for applications by capturing the features of each application in a numerical format and ingesting the vector representations into a vector database for efficient querying and retrieval; employing a clustering-based model to analyze raw vector database to group similar application vectors together and create a fine-grained vector database; performing vector similarity searches using the fine-grained vector database; comparing application feature vector to vectors in the fine-grained vector database and identifying closest matches; and utilizing a scheduler manager to call a vector similarity searcher and find appropriate nodes for scheduling the applications to determine the suitable nodes based on the matching vectors. Embodiments of the present invention also analyze characteristics and extracted information based on features of the new applications.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), crasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as application scheduler code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

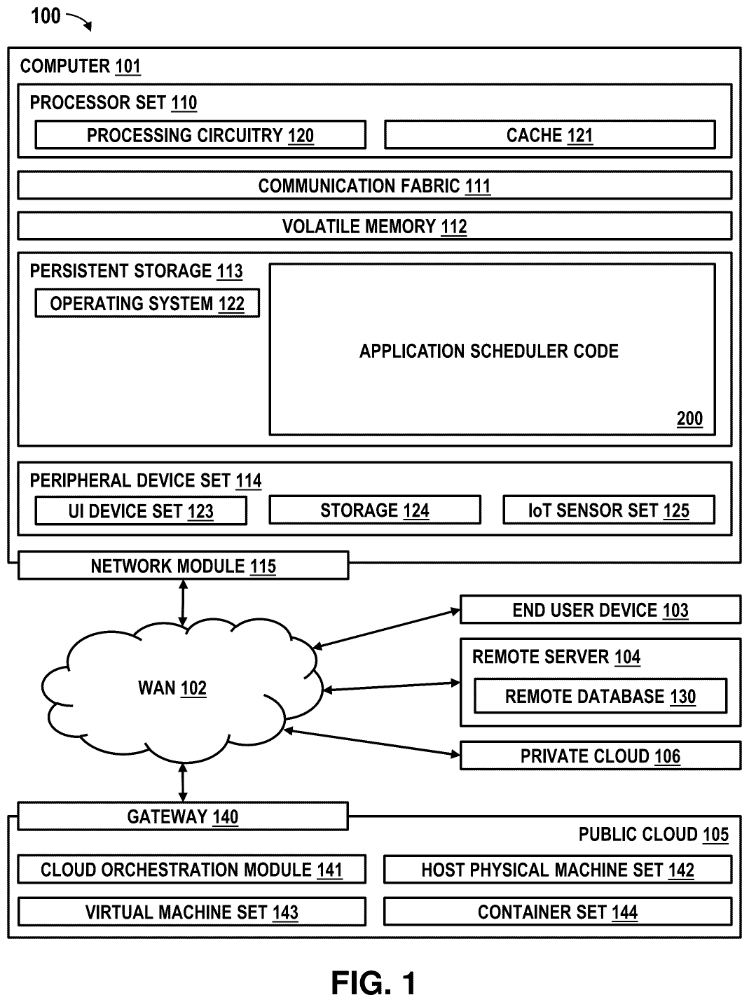

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

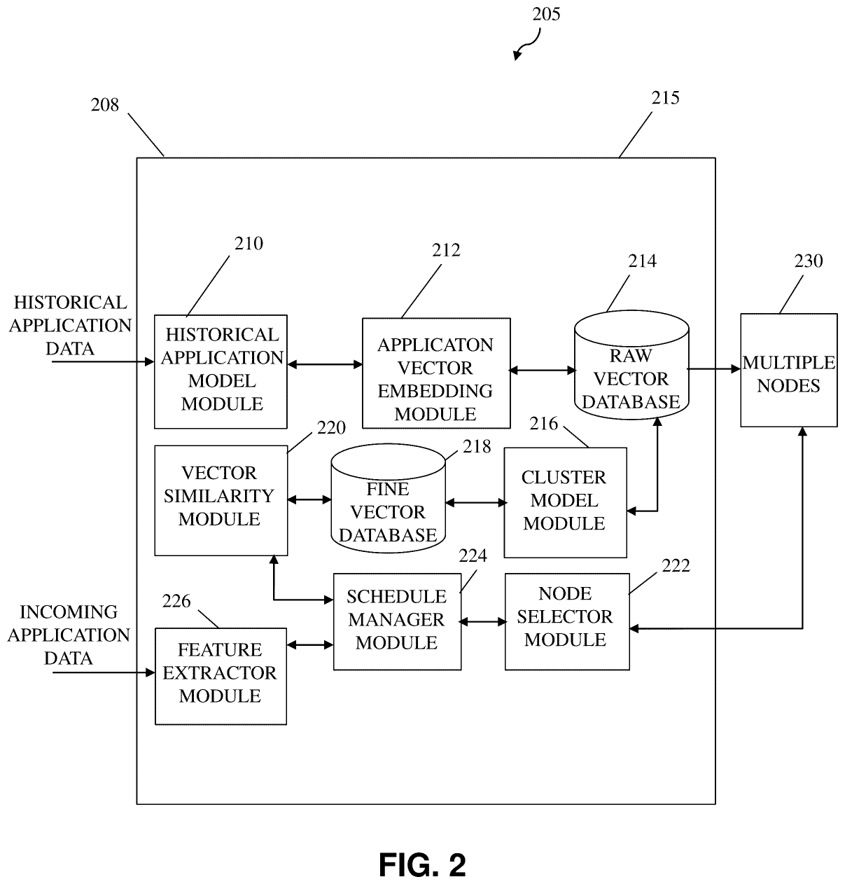

FIG. 2 shows a block diagram of an exemplary environment 205 in accordance with aspects of the present invention. In embodiments, the environment 205 includes an application schedule server 208, which may comprise one or more instances of the computer 101 of FIG. 1. In other examples, the application schedule server 208 comprises one or more virtual machines or one or more containers running on one or more instances of the computer 101 of FIG. 1.

In embodiments, the application schedule server 208 of FIG. 2 comprises a historical application model module 210, an application vector embedding module 212, a cluster model module 216, a vector similarity module 220, a node selector module 222, a schedule manager module 224, and a feature extractor module 226, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the present invention as described herein. These modules of the code of block 200 are executable by the processing circuitry 120 of FIG. 1 to perform the inventive methods as described herein. The application schedule server 208 may include additional or fewer modules than those shown in FIG. 2. For example, the application schedule server 208 may also include a raw vector database 214 and a fine vector database 218. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In accordance with aspects of the present invention, the historical application model module 210 receives historical application data from at least one application of a user device. In embodiments, the historical application data represents past data from at least one application of the user device that has run at a previous time relative to a current application. In further embodiments, the historical application data includes a comprehensive dataset including application type, resource usage, performance metrics, and any other relevant attributes. In an example, the performance metrics include performance, usage, and resource requirements which correspond with past data from applications and cloud services. The performance metrics which correspond with applications and cloud services encompass a plurality of factors including computational complexity, memory usage, network traffic patterns, response time, scalability, and reliability. Further, the performance metrics are quantitative indicators of behavior and requirements of the applications and cloud services. In embodiments, the historical application model module 210 analyzes and pre-processes the historical application data by cleaning, organizing, and normalizing the historical application data be ensuring consistency and removing outliers and inconsistent data. In particular, the historical application model module 210 analyzes the performance metrics to determine an optimal scheduling and allocations of applications and cloud services within a distributed system. The historical application model module 210 extracts features from the pre-processed historical application data by using statistical analysis, machine learning models, and domain-specific knowledge to identify and determine relevant characteristics and properties of the historical applications. In an example, the historical application model module 210 extracts the features from the pre-processed historical application data by using machine learning models which include linear regression and clustering algorithms. In embodiments, the historical application model module 210 labels the extracted features. For example, the historical application model module 210 labels an extracted feature as resource usage intensive. In embodiments, the historical application model module 210 builds and trains a historical application model which incorporates the extracted features. The historical application model module 210 builds and trains the historical application model which incorporates the extracted features by utilizing a random forest algorithm based on multiple trees to classify the extracted features for quick and efficient conversion of the extracted features. The historical application model of the historical application model module 210 sends the extracted features to the application vector embedding module 212.

In embodiments, the application vector embedding module 212 converts the extracted features to feature vectors by converting the extracted features into a numerical representation using embedding and dimensionality reduction algorithms. In an example, each feature vector may include numerical representations which correspond with resource requirements, execution times, data size, dependencies, and priorities. In embodiments, the application vector embedding module 212 stores the feature vectors for each application in the raw vector database 214 for efficient querying and retrieval of the feature vectors. The raw vector database 214 then communicates the feature vectors with the cluster model module 216 and the multiple nodes 230. In embodiments, the multiple nodes 230 includes a plurality of nodes, each of which may comprise an instance of an end user device 103 of FIG. 1. Further, in embodiments, each of the plurality of nodes in the multiple nodes 230 can be used to schedule applications for execution.

In accordance with aspects of the present invention, the cluster model module 216 prepares the feature vectors from the raw vector database 214 for clustering by standardizing the feature vectors, handling missing values, etc. In embodiments, the cluster model module 216 then runs a clustering algorithm on the prepared feature vectors by feeding the prepared feature vectors into a clustering algorithm to identify clusters based on a similarity or distance between the prepared vector features. In embodiments, the cluster model module 216 utilizes one of a selected k-means algorithm, hierarchical clustering algorithm, etc. as the clustering algorithm based on system requirements and characteristics of the feature vectors. In further embodiments, the cluster model module 216 adjusts parameters of the clustering algorithm by adjusting a number of clusters (e.g., k clusters) or distance metrics to obtain desired clustering results. The cluster model module 216 then sends the clustering results to the fine vector database 218. In embodiments, the fine vector database 218 organizes the feature vectors of historical applications based on their respective clusters. The fine vector database 218 then assigns a cluster label or identifier to each feature vector to indicated a group membership. In embodiments, the fine vector database 218 facilitates efficient retrieval and grouping of the feature vectors of historical applications. The fine vector database 218 then sends the feature vectors of historical applications and corresponding clusters to the vector similarity module 220.

With continued reference to FIG. 2, and in accordance with aspects of the present invention, the feature extractor module 226 receives incoming application data. In embodiments, the incoming application data corresponds to current application data. The feature extractor module 226 extracts features from the incoming application data by using statistical analysis, machine learning models, and domain-specific knowledge to identify and determine relevant characteristics and properties of the incoming applications. In an example, the feature extractor module 226 extracts the features from the incoming application data by using machine learning models which include linear regression and clustering algorithms. In embodiments, the feature extractor module 226 labels the extracted features (e.g., labels an extracted feature as resource usage intensive). The feature extractor module 226 then converts the extracted features to feature vectors by converting the extracted features into the numerical representation using embedding and dimensionality reduction algorithms. In an example, each feature vector may include numerical representations which correspond with resource requirements, execution times, data size, dependencies, and priorities. The feature extractor module 226 then sends the feature vectors corresponding to the incoming application data to the schedule manager module 224. The schedule manager module 224 sends the feature vectors corresponding to the incoming application data to the vector similarity module 220.

In accordance with aspects of the present invention, the vector similarity module 220 performs a vector similarity search by comparing the feature vectors of historical applications in the fine vector database 218 to the feature vectors corresponding to the incoming application data. In embodiments, the vector similarity module 220 identifies closest vector matches based on the comparison between the feature vectors of historical application to the feature vectors corresponding to the incoming application data. The vector similarity module 220 sends the closest matches to the scheduled manager module 224.

In further embodiments, the vector similarity module 220 may determine that there are no vector matches between a comparison of the feature vectors of historical applications in the fine vector database 218 and the feature vectors corresponding to the incoming application data. In further embodiments, the schedule manager module 224 dynamically schedules execution of the current application using proper nodes. In embodiments, the scheduler manager module 224 determines the proper nodes for execution of the current application by communicating with the node selector module 222. The node selector module 222 determines characteristics of a plurality of nodes within the multiple nodes 230 and sends the determined characteristics of the plurality of nodes to the schedule manager module 224. Accordingly, in embodiments, the schedule manager module 224 determines the proper nodes in the multiple nodes 230 for execution of the current application based on the determined characteristics of the plurality of nodes received from the node selector module 222 and the feature vectors corresponding to the incoming application data.

In accordance with aspects of the present invention, the schedule manager module 224 receives the closest vector matches and schedules execution of the current application by determining a suitable node using the closest vector matches. The schedule manager module 224 determines the suitable node for execution of the current application by communicating with the node selector module 222. The node selector module 222 determines characteristics of a plurality of nodes within the multiple nodes 230 and sends the determined characteristics of the plurality of nodes to the schedule manager module 224. Accordingly, in embodiments, the schedule manager module 224 determines the suitable node in the multiple nodes 230 for execution of the current application based on the determined characteristics of the plurality of nodes received from the node selector module 222 and the closest vector matches. The schedule manager module 224 then sends information about the suitable node to the node selector module 222. The node selector module 222 then sends instructions for the current application to be executed by the suitable node within the multiple nodes 230 to the multiple nodes 230. Finally, the multiple nodes 230 executes the current application using the suitable node included in the instructions from the node selector module 222.

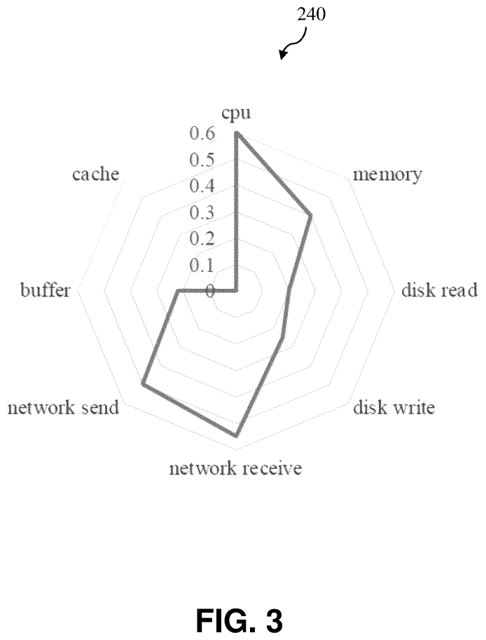

FIG. 3 shows a diagram in accordance with aspects of the present invention. In FIG. 3, a cloud service metrics radar diagram 240 includes a plurality of performance metrics which are included in the historical application data received at the historical application model module 210. In embodiments, the plurality of performance metrics include a central processing unit (CPU) metric, a memory metric, a disk read metric, a disk write metric, a network receive metric, a buffer metric, and a cache metric. In an example of FIG. 3, the cloud service metrics radar diagram 240 shows that the metrics have an intensive CPU metric (e.g., CPU metric is 0.6), an intensive network send (e.g., network send metric is 0.5), and an intensive network receive (e.g., network receive metric is 0.55).

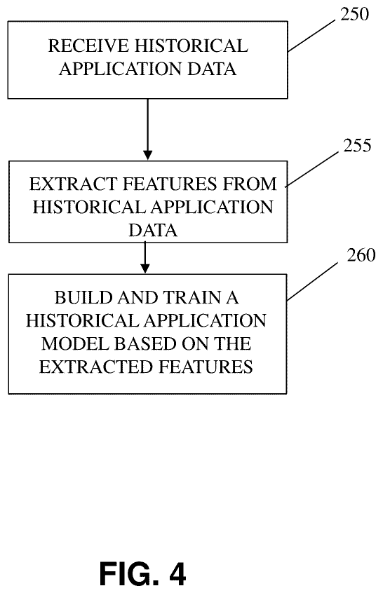

FIG. 4 shows a flowchart of an exemplary method in accordance with aspects of the present invention. Steps of the method may be carried out in the environment of FIG. 2 and are described with reference to elements depicted in FIG. 2.

In embodiments of FIG. 4, at step 250, the system receives, at the historical application model module 210, historical application data. In embodiments and as described with FIG. 2, the historical application data corresponds with historical data from at least one application.

At step 255, the system extracts, at the historical application model module 210, features from the historical application data. In embodiments and as described with FIG. 2, the historical application model module 210 extracts the features from the historical application data by using machine learning models, statistical analysis, and domain-specific knowledge to identify and determine characteristics and properties of the historical application.

At step 260, the system builds and trains, at the historical application model module 210, a historical application model which incorporates the extracted features. In embodiments and as described with FIG. 2, the historical application model module 210 builds and trains the historical application model by utilizing a random forest algorithm based on multiple tress to classify the extracted features.

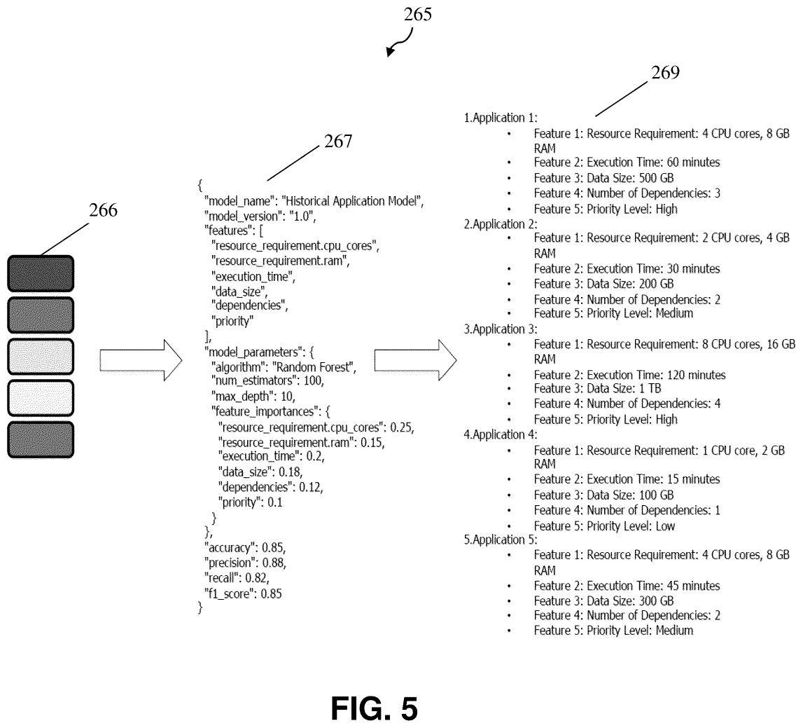

FIG. 5 shows a diagram 265 in accordance with aspects of the present invention. In FIG. 5, the historical application model module 210 utilizes the historical application data 266 to train and build the historical application model. In particular, the historical application model includes parameters and features 267. Further, in embodiments the historical application model of the historical application model module 210 organizes and classifies the historical application data 266 into applications and their corresponding features 269.

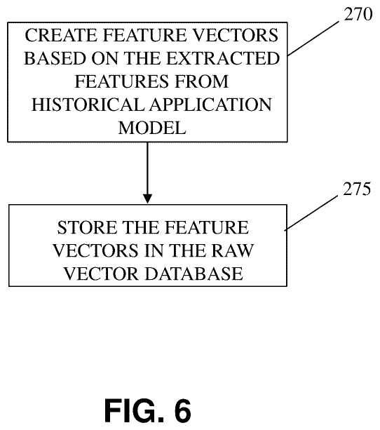

FIG. 6 shows a flowchart of another exemplary method in accordance with aspects of the present invention. Steps of the method may be carried out in the environment of FIG. 2 and are described with reference to elements depicted in FIG. 2.

In embodiments of FIG. 6, at step 270, the system creates, at the application vector embedding module 212, feature vectors based on the extracted features from the historical application model of the historical application model module 210. In embodiments and as described with FIG. 2, each of the feature vectors includes numerical representations which correspond with resource requirements, execution times, data size, dependencies, and priorities.

In step 275, the system stores, at the application vector embedding module 212, the feature vectors for each application in the raw vector database 214 for efficient querying and retrieval of the feature vectors. In embodiments and as described with FIG. 2, the raw vector database 214 communicates the feature vectors with the cluster model module 216 and the multiple nodes 230.

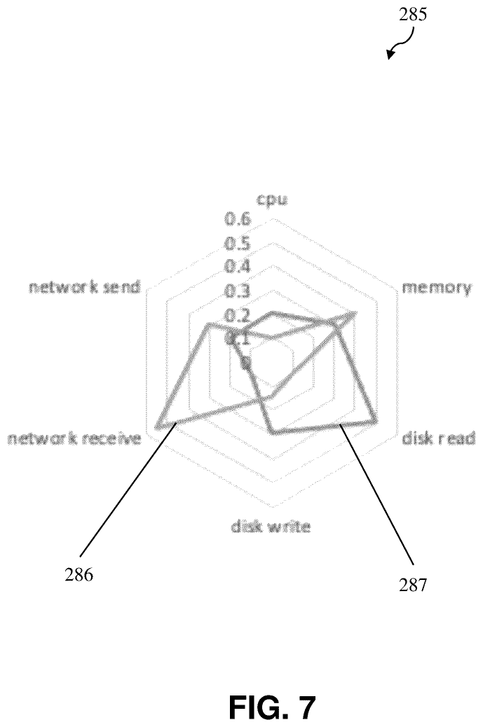

FIG. 7 shows a diagram in accordance with aspects of the present invention. In FIG. 7, a cloud services metrics radar diagram 285 includes data from a first cloud service 286 and a second cloud service 287 which includes a plurality of performance metrics included in the historical application data received at the historical application model module 210. In embodiments, the plurality of performance metrics include a central processing unit (CPU) metric, a memory metric, a disk read metric, a disk write metric, a network receive metric, a buffer metric, and a cache metric.

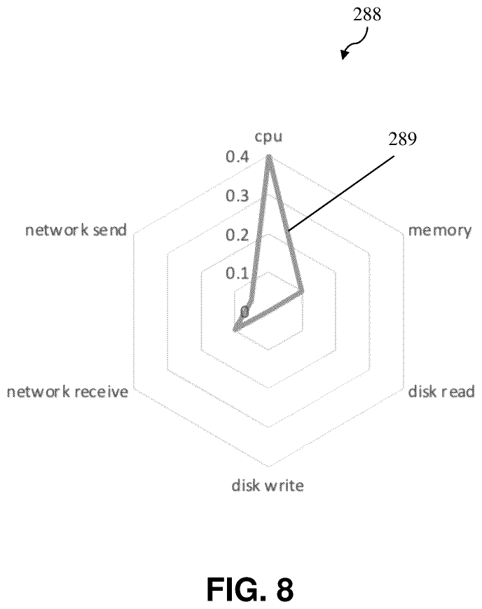

FIG. 8 shows a diagram in accordance with aspects of the present invention. In FIG. 8, a cloud service metrics radar diagram 288 includes data from a third cloud service 289 which includes a plurality of performance metrics included in the historical application data received at the historical application model module 210. In embodiments, the plurality of performance metrics include a central processing unit (CPU) metric, a memory metric, a disk read metric, a disk write metric, a network receive metric, a buffer metric, and a cache metric.

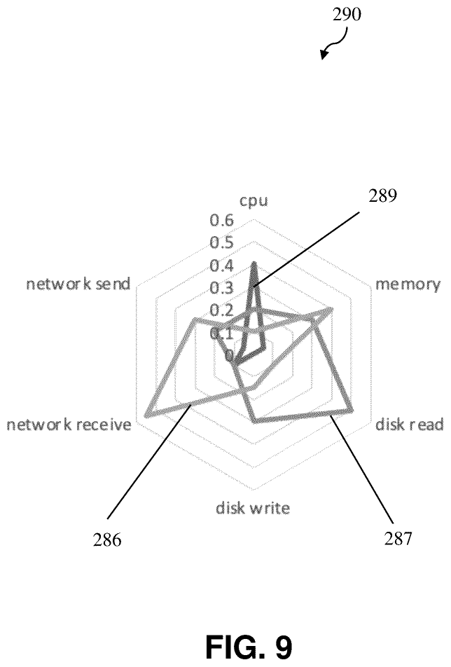

FIG. 9 shows a diagram in accordance with aspects of the present invention. In embodiments of the present invention, a cloud service simulated scheduling diagram 290 includes data from the first cloud service 286, the second cloud service 287, and the third cloud service 289 which includes a plurality of performance metrics included in the historical application data received at the historical application model module 210. In embodiments, the plurality of performance metrics include a central processing unit (CPU) metric, a memory metric, a disk read metric, a disk write metric, a network receive metric, a buffer metric, and a cache metric.

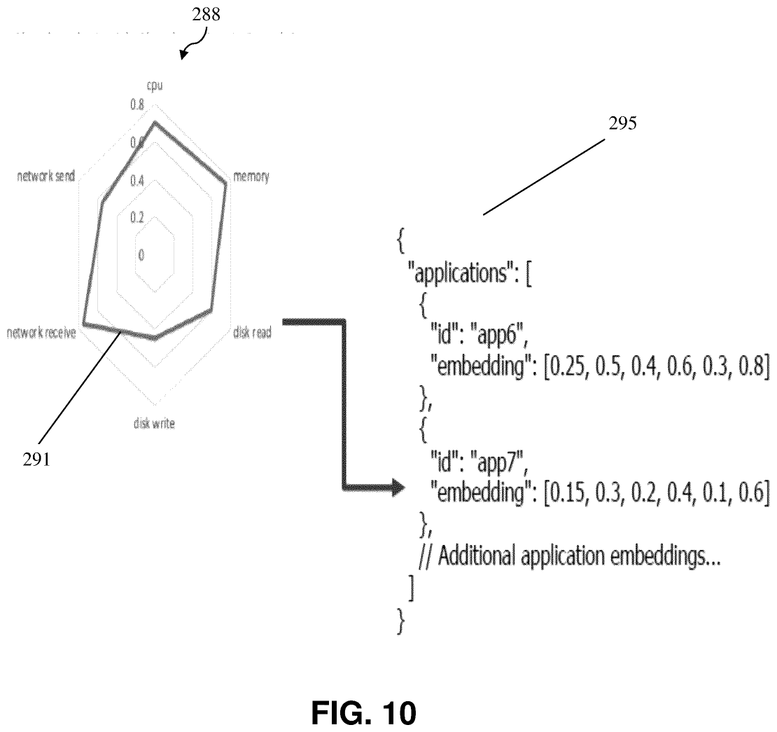

FIG. 10 shows a diagram in accordance with aspects of the present invention. In FIG. 10, the cloud node with the cloud service metrics radar diagram 288 which includes a combination of data 291 from the first cloud service 285, the second cloud service 287, and the third cloud service 289. FIG. 10 also shows an example of a software snippet 295 which corresponds with the cloud services metrics radar diagram 288. In this example, the software snippet 295 includes application identities (e.g., app6 and app7) and corresponding embeddings of historical application data.

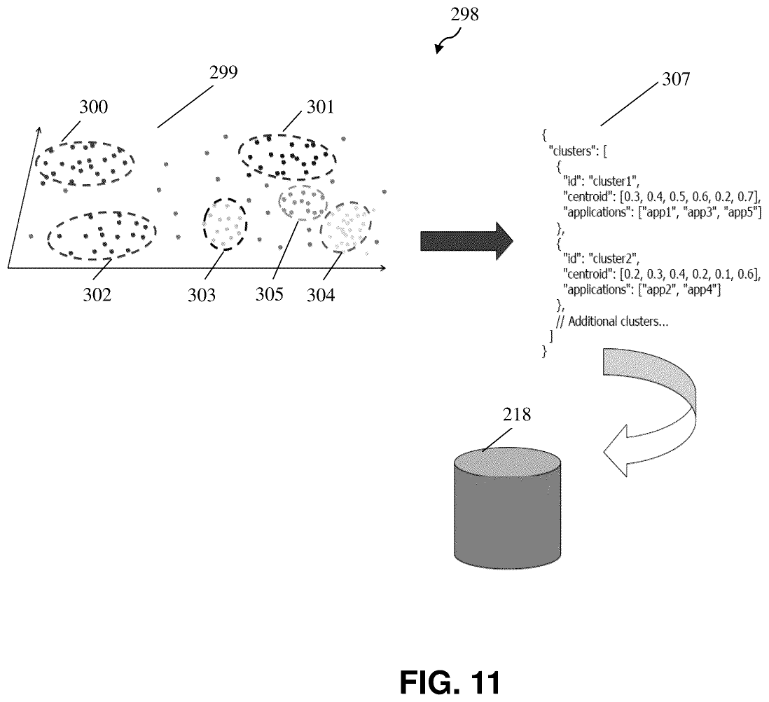

FIG. 11 shows a diagram in accordance with aspects of the present invention. In FIG. 11, the diagram 298 includes a cluster model graph 299 which includes a first cluster 300 which corresponds with the CPU, memory, input/output (IO) utilization, a second cluster 301 which corresponds with a balanced resource, a third cluster 302 which corresponds with memory exhaustion, a fourth cluster 303 which corresponds with CPU competition, a fifth cluster 304 which corresponds with network IO competition, and a sixth cluster 305 which corresponds with storage IO competition. In embodiments of FIG. 11, the cluster model module 216 clusters the feature vectors to the first cluster 300, the second cluster 301, the third cluster 302, the fourth cluster 303, and the fifth cluster 304 based on system requirements and characteristics of the feature vectors (e.g., CPU, memory, IO utilization, balanced resource, memory exhaustion, CPU competition, network IO competition, and storage IO competition). FIG. 11 also shows a software snippet 307 which corresponds with the cluster model graph 299. In this example, the software snippet 307 comprises clustering results including cluster identities (e.g., cluster1 and cluster2) and corresponding centroids and applications. In embodiments of FIG. 11, the clustering results are stored in the fine vector database 218.

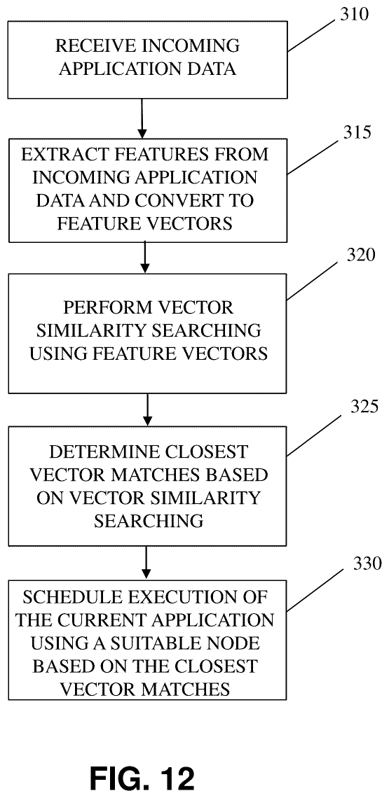

FIG. 12 shows a flowchart of another exemplary method in accordance with aspects of the present invention. Steps of the method may be carried out in the environment of FIG. 2 and are described with reference to elements depicted in FIG. 2.

In embodiments of FIG. 12, at step 310, the system receives, at the feature extractor module 226, incoming application data. In embodiments and as described with FIG. 2, the incoming application data corresponds with current application data. In embodiments, the current application data is data from a currently executing application and the historical application data is past data from a previously executed application.

At step 315, the system extracts, at the feature extractor module 226, features from the incoming application data. In embodiments and as described with FIG. 2, the feature extractor module 226 extracts the features from the incoming application data by using machine learning models, statistical analysis, and domain-specific knowledge to identify and determine characteristic and properties of the incoming applications. In further embodiments, the feature extractor module 226 then converts the extracted features to feature vectors by converting the extracted features into the numerical representation using embedding and dimensionality reduction algorithms.

At step 320, the system performs, at the vector similarity module 220, a vector similarity search. In embodiments and as described with FIG. 2, the vector similarity module 220 performs the vector similarity search by comparing the feature vectors of historical applications in the fine vector database 218 to the feature vectors corresponding the incoming application data.

At step 325, the system determines, at the vector similarity module 220, closest vector matches based on the comparison between the feature vectors of the historical applications to the feature vectors corresponding to the incoming application data. In embodiments and as described with FIG. 2, the vector similarity module 220 sends the closest vector matches to the schedule manager module 224.

At step 330, the system schedules, at the schedule manager module 224, execution of the current application by determining a suitable node using the closest vector matches. In embodiments and as described with FIG. 2, the schedule manager module 224 determines the suitable node for execution of the current application by communicating with the node selector module 220.

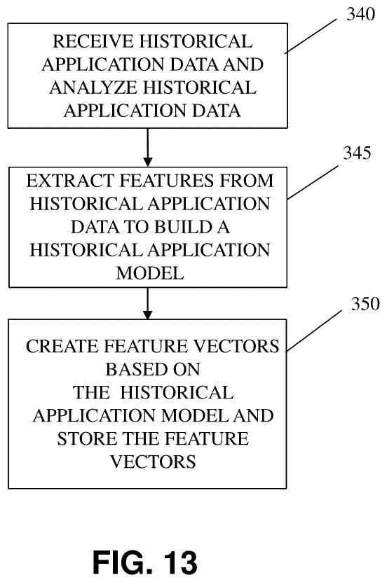

FIG. 13 shows a flowchart of another exemplary method in accordance with aspects of the present invention. Steps of the method may be carried out in the environment of FIG. 2 and are described with reference to elements depicted in FIG. 2.

At step 340, the system receives, at the historical application model module 210, historical application data from at least one application of a user device. In embodiments and as described with FIG. 2, the historical application model module 210 also pre-processes the historical application data by cleaning, organizing, and normalizing the historical application data.

At step 345, the system extracts, at the historical application model module 210, features from the historical application data to build a historical application model. In embodiments and as described with FIG. 2, the historical application model module 210 extracts the features from the historical application by using statistical analysis, machine learning models, and domain-specific knowledge to identify and determine relevant characteristics and properties of the historical applications. In further embodiments, the historical application model module 210 builds the historical application model which incorporates the extracted features by utilizing a random forest algorithm based on multiple trees to classify the extracted features.

At step 350, the system creates, at the application vector embedding module 212, feature vectors by converting the extracted features into a numerical representation using embedding and dimensionality reduction algorithms and storing the created feature vectors. In embodiments and as described with FIG. 2, the numerical representation corresponds with resource requirements, execution times, data size, dependencies, and priorities.

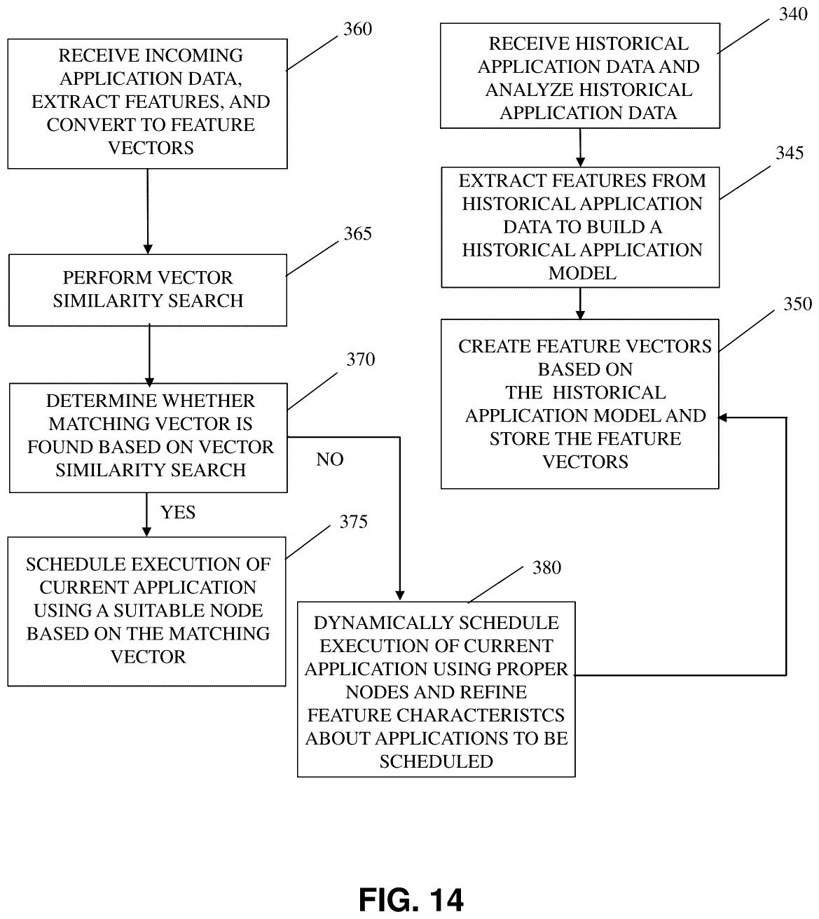

FIG. 14 shows a flowchart of another exemplary method in accordance with aspects of the present invention. Steps of the method may be carried out in the environment of FIG. 2 and are described with reference to elements depicted in FIG. 2.

At step 340, the system receives, at the historical application model module 210, historical application data from at least one application of a user device. In embodiments and as described with FIG. 2, historical application model module 210 also pre-processes the historical application data by cleaning, organizing, and normalizing the historical application data.

At step 345, the system extracts, at the historical application model module 210, features from the historical application data to build a historical application model. In embodiments and as described with FIG. 2, the historical application model module 210 extracts the features from the historical application by using statistical analysis, machine learning models, and domain-specific knowledge to identify and determine relevant characteristics and properties of the historical applications. In further embodiments, the historical application model module 210 builds the historical application model which incorporates the extracted features by utilizing a random forest algorithm based on multiple trees to classify the extracted features.

At step 350, the system creates, at the application vector embedding module 212, feature vectors by converting the extracted features into a numerical representation using embedding and dimensionality reduction algorithms and storing the created feature vectors. In embodiments and as described with FIG. 2, the numerical representation corresponds with resource requirements, execution times, data size, dependencies, and priorities.

At step 360, the system receives, at the feature extractor module 226, incoming application data. In embodiments and as described with FIG. 2, the feature extractor module 226 extracts features from the incoming application data using statistical analysis, machine learning models, and domain-specific knowledge to identify and determine relevant characteristics and properties of the incoming applications. In further embodiments, the feature extractor module 226 then converts the extracted features to feature vectors by converting the extracted features into the numerical representation using embedding and dimensionality reduction algorithms.

At step 365, the system performs, at the vector similarity module 220, a vector similarity search. In embodiments and as described with FIG. 2, the vector similarity module 220 performs the vector similarity search by comparing the feature vectors of historical applications in the fine vector database 218 to the feature vectors corresponding to in the incoming application data.

At step 370, the system determines, at the vector similarity module 220, whether a matching vector is found based on the vector similarity search. In embodiments and as described with FIG. 2, the flowchart moves to step 375 in response to determining that the matching vector is found based on the vector similarity search. In further embodiments, the flowchart moves to step 380 in response to determining that no matching vector is found based on the vector similarity search.

At step 375, the system schedules, at the scheduler manager module 224, execution of the current application using a suitable node based on the matching vector. In embodiments and as described with FIG. 2, the scheduler manager module 224 determines the suitable node for execution of the current application by communicating with the node selector module 222.

At step 380, the system dynamically schedules, at the schedule manager module 224, execution of the current application using proper nodes. In embodiments and as described with FIG. 2, the scheduler manager module 224 determines the proper nodes for execution of the current application by communicating with the node selector module 222. In further embodiments, the schedule manager module 224 refines feature characteristics about applications to be scheduled. After step 380 is performed, the flowchart moves to step 350.

In embodiments, a service provider could offer to perform the processes described herein. In this case, the service provider can create, maintain, deploy, support, etc., the computer infrastructure that performs the process steps of the present invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the present invention provides a computer-implemented method, via a network. In this case, a computer infrastructure, such as computer 101 of FIG. 1, can be provided and one or more systems for performing the processes of the present invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the present invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a processor set, historical application data about at least one historical application;
receiving, by the processor set, incoming application data from at least one incoming application;
extracting, by the processor set, a first set of features from the historical application data and a second set of features from the incoming application data using at least one machine learning model;
converting, by the processor set, the first set of features to a first set of feature vectors and the second set of features to a second set of feature vectors;
performing, by the processor set, a vector similarity search by comparing the first set of feature vectors to the second set of feature vectors;
determining, by the processor set, a matching vector based on the vector similarity search; and
scheduling, by the processor set, execution of the at least one incoming application using a node based on the matching vector.

2. The computer-implemented method of claim 1, wherein the at least one incoming application comprises at least one current application.

3. The computer-implemented method of claim 1, wherein the extracting the first set of features comprises extracting the features from the at least one historical application by using the at least one machine learning model to identify characteristics and properties of the at least one historical application.

4. The computer-implemented method of claim 3, wherein the at least one machine learning model comprises a linear regression algorithm.

5. The computer-implemented method of claim 3, wherein the at least one machine learning model comprises a clustering algorithm.

6. The computer-implemented method of claim 1, wherein the extracting the second set of features comprises extracting the features from the at least one incoming application by using the at least one machine learning model to identify characteristics and properties of the at least one incoming application.

7. The computer-implemented method of claim 1, further comprising pre-processing the historical application data by cleaning, organizing, and normalizing the historical application data.

8. The computer-implemented method of claim 1, further comprising:
storing the first set of vector features in a raw vector database for querying and retrieval of the first set of vector features;
clustering the stored first set of vector features;
storing the clustered first set of vector features in a fine vector database; and
assigning a cluster label to each stored clustered first set of vector features to indicated a group membership.

9. The computer-implemented method of claim 1, further comprising building and training a historical application model by incorporating the first set of features.

10. The computer-implemented method of claim 9, further comprising:
classifying the first set of features by utilizing the historical application model with a random forest algorithm based on multiple trees; and
converting the classified first set of features to the first set of vector features.

11. The computer-implemented method of claim 1, further comprising clustering the first set of feature vectors to identify clusters based on a distance between the first set of feature vectors.

12. A computer program product comprising one or more computer readable storage media having program instructions collectively stored on the one or more computer readable storage media, the program instructions executable to:
receive historical application data about at least one historical application;
receive incoming application data from at least one incoming application;
extract a first set of features from the historical application data and a second set of features from the incoming application data using at least one machine learning model;
convert the first set of features to a first set of feature vectors and the second set of features to a second set of feature vectors;
perform a vector similarity search by comparing the first set of feature vectors to the second set of feature vectors;
determine a matching vector based on the vector similarity search; and
schedule execution of the at least one incoming application using a node based on the matching vector.

13. The computer program product of claim 12, wherein the at least one incoming application comprises at least one current application.

14. The computer program product of claim 12, wherein the extracting the first set of features comprises extracting the features from the at least one historical application by using the at least one machine learning model to identify characteristics and properties of the at least one historical application.

15. The computer program product of claim 12, wherein the extracting the second set of features comprises extracting the features from the at least one incoming application by using the at least one machine learning model to identify characteristics and properties of the at least one incoming application.

16. The computer program product of claim 12, further comprising building and training a historical application model by incorporating the first set of features.

17. The computer program product of claim 16, further comprising:
classifying the first set of features by utilizing the historical application model with a random forest algorithm based on multiple trees; and
converting the classified first set of features to the first set of vector features.

18. The computer program product of claim 12, further comprising clustering the first set of feature vectors to identify clusters based on a distance between the first set of feature vectors.

19. The computer program product of claim 12, further comprising executing the at least one incoming application using the node.

20. A system comprising:
a processor set, one or more computer readable storage media, and program instructions collectively stored on the one or more computer readable storage media, the program instructions executable to:
receive historical application data about at least one historical application;
receive incoming application data from at least one incoming application;
extract a first set of features from the historical application data and a second set of features from the incoming application data using at least one machine learning algorithm;
convert the first set of features to a first set of feature vectors and the second set of features to a second set of feature vectors;
perform a vector similarity search by comparing the first set of feature vectors to the second set of feature vectors;
determine a matching vector based on the vector similarity search;
schedule execution of the at least one incoming application using a node based on the matching vector; and
execute the at least one incoming application using the node.
